(19) United States
(12) Patent Application Publication
(10) Pub. No.: US 2017/0196058 A1
(43) Pub. Date: Jul. 6, 2017

(54) Lighting device with color temperature gradation and method of using the same

(71) Applicant: ARTIKA FOR LIVING INC., Dorval (CA)

(72) Inventor: Dave Morneau, Mont St-Hilaire (CA)

(21) Appl. No.: 15/399,660

(22) Filed: Jan. 5, 2017

Related U.S. Application Data
(60) Provisional application No. 62/275,208, filed on Jan. 5, 2016.

(51) Int. Cl. H05B 33/08

(52) U.S. Cl. CPC H05B 33/0815; H05B 33/0845; H05B 33/0869

(57) ABSTRACT

A lighting device with color temperature gradation is disclosed. The lighting device has a first white light emitting diode (LED) source with a first color temperature and a second white LED source with a second color temperature. The lighting device further comprises a controller adapted to generate a pulse width modulation (PWM) signal and to supply the first white LED with a first portion of the PWM signal and the second white LED with a second portion of the PWM signal in order to obtain a collective output of the lighting device with an output color temperature in between of a first color temperature and the second color temperature. The method of gradating the color temperature of a lighting device is also disclosed.

### CROSS-REFERENCE TO RELATED APPLICATIONS

The present patent application claims the benefits of priority of U.S. Patent Application No. 62/275,208, entitled “Temperature color gradation LED lighting device and method of using the same”, and filed at the US Patent Office on Jan. 5, 2016, the content of which is incorporated herein by reference.

### FIELD OF THE INVENTION

The present invention generally relates to LED lighting devices and more particularly to LED lighting devices having temperature color variations and dimming capabilities.

### BACKGROUND OF THE INVENTION

To produce a variation in the temperature of white light produced by a LED lighting device, existing LED lighting devices typically use temperature variation of the wavelength of the emitted light. The color temperature of a light source corresponds to the temperature of an ideal black-body radiator that radiates light of comparable hue to that of the light source. Color temperature is conventionally stated in the unit of absolute temperature, the Kelvin, having the unit symbol K. Color temperatures over 5,000 K are known as cool colors (bluish white), while lower color temperatures (2,700-3,000 K) are known as warm colors (yellowish white through red). Generally, the variation of the color temperature of a white light engine is produced by adding to the lighting device one or more LEDs having a fixed wavelength.

For example, a white 4000K light engine (moonlight) is generally combined to one or more amber (590 nm) LEDs to obtain a white with a warmer appearance (i.e. reproducing a soft white incandescent lamp).

Such principle allows the lighting device to vary by producing a gradation of these different light sources. A simple primary dimmer can act both as a normal dimmer combined with a white temperature differentiator.

However, the use of color LED in combination with a white LED limits the quality of the perceived colors of objects illuminated by such a light engine.

Therefore, there is a need for a LED device that at least mitigates the short coming of the prior art.

### SUMMARY OF THE INVENTION

The shortcomings of the prior art are generally mitigated by providing a light engine system or lighting device having color temperature gradation capabilities while minimizing the limiting effect obtained by the resulting combination of the various light sources.

According to one aspect of the present invention, the present lighting device is able to control the apparent Kelvin temperature of light emitted from a light bulb such as a LED.

According to one aspect of the present invention, the present lighting device is designed for white light temperature color gradation while generally preserving the quality of the final white light rendering. The As such, the lighting device, in accordance with an aspect of the present invention, has two different white LED light sources (e.g. one being warm such as 2700K and one being cold such as 6000K) used to obtain a harmonized palette of white lights.

According to an aspect of the present invention, of the two different white LED light sources may be controlled using a signal from a home automation mesh network such as Zigbee™.

According to an aspect of the present invention, a method of controlling/gradating the color temperature of a white LED light engine is disclosed.

According to one aspect of the present invention, a lighting device with color temperature gradation is provided. The lighting device comprises a first light source having a first color temperature; a second light source, having a second color temperature, the second color temperature being higher than the first color temperature; and a controller. The controller is fed by an electric signal and connected with the first light source and with the second light source. The controller is configured to generate a pulse width modulation (PWM) signal and supply the first light source with a first portion of the PWM signal and the second light with a second portion of the PWM signal.

The color temperature of the second light source may be higher than the color temperature of the first light source by at least 2200 Kelvin (K).

The first light source and the second light source may be Light-Emitting Diodes (LEDs). The first light source and the second light source may be white LEDs. The first light source may be a cold color temperature LED and the second light source may be a warm color temperature LED. The color temperature of the second light source may be higher than the color temperature of the first light source by at least 2200 Kelvin (K).

The first portion of the PWM signal may be comprised between 0% to 100% of the PWM signal and the second portion of the PWM signal may be comprised between 0% to 100% of the PWM signal.

The controller may be a high frequency PWM controller. The PWM signal generated by the controller may have a frequency between 20,000 Hz and 40,000 Hz.

The first color temperature may be between 2800K and 3200K. The second color temperature may be between 5500K and 6000K.

The lighting device may further comprise a temperature sensor connected to the controller and configured to provide a feedback signal to the controller. The lightning device may further comprise a first and a second Schottky diodes, the first Schottky diode being connected to the first light source and the second Schottky diode being connected to the second light source.

According to one aspect of the present invention, a method of gradating the color temperature of a lighting device is provided. The method comprises the steps of generating a pulse width modulation (PWM) signal; supplying a first light source with a first portion of the generated PWM signal, the light source having a first color temperature; supplying a second light source with a second portion of the PWM signal, the second light source having a second color temperature; and emitting a light having an output color temperature in between of the first color temperature and the second color temperature.

The method may also comprise varying the first portion of the PWM signal to be comprised in a range of 0% to 100% of the PWM signal. The method may further comprise varying the second portion of the PWM signal to be comprised in a range of 0% to 100% of the PWM signal.

The second color temperature may be at least 2200K higher than the first color temperature. The first light source may be a cold color temperature LED and the second light source may be a warm color temperature LED. The PWM signal may be generated by a controller fed by electric current and connected to the first and second light sources.

### BRIEF DESCRIPTION OF THE DRAWINGS

The above and other aspects, features and advantages of the invention will become more readily apparent from the following description, reference being made to the accompanying drawings in which:

FIG. 1 is a scheme of the electronic components of a lighting device, in accordance with one embodiment.

FIG. 2 is a scheme of the output power control according to the gradation in Kelvin, in accordance with the principles of the present invention.

FIG. 3 is an example of chromatic shifting versus current of the lighting device in accordance with the principles of the present invention.

FIG. 4 is an example of controlling of dimming (gradation) the lighting device, in accordance with the principles of the present invention.

FIG. 5 is an example of output color temperature as a function of the Pulse Width Modulation (PWM), in accordance with the principles of the present invention.

### DETAILED DESCRIPTION OF THE PREFERRED EMBODIMENT

A lighting device with color temperature gradation (dimming) and method of using the same will be described hereinafter. Although the invention is described in terms of specific illustrative embodiments, it is to be understood that the embodiments described herein are by way of example only and that the scope of the invention is not intended to be limited thereby.

It should be noted that the terms “lighting device” and “light engine” are used herein interchangeably.

Within the context of the present disclosure, Pulse Width Modulation, or PWM, is a technique for getting analog results with digital means. Digital control is used to create a square wave, a signal switched between on and off.

According to embodiments of the present invention, a lighting device producing white light color temperature gradation, while generally preserving the quality of the final white light rendering, is disclosed. Therefore, the lighting device in accordance with an aspect of the present invention comprises at least two white LED light sources emitting different color temperatures (e.g. one of 2700K and one of 6000K) which may be combined to obtain a harmonized palette of white lights.

Unlike other methods normally used for color LEDs, the intensity of white LEDs does not vary as a function of voltage provided to each of the LED light sources. Indeed, variations of the voltage feeding a white light engine generally result in a color-drift phenomenon. Such color-drift phenomenon is not desirable when gradating the color temperature of the light engine.

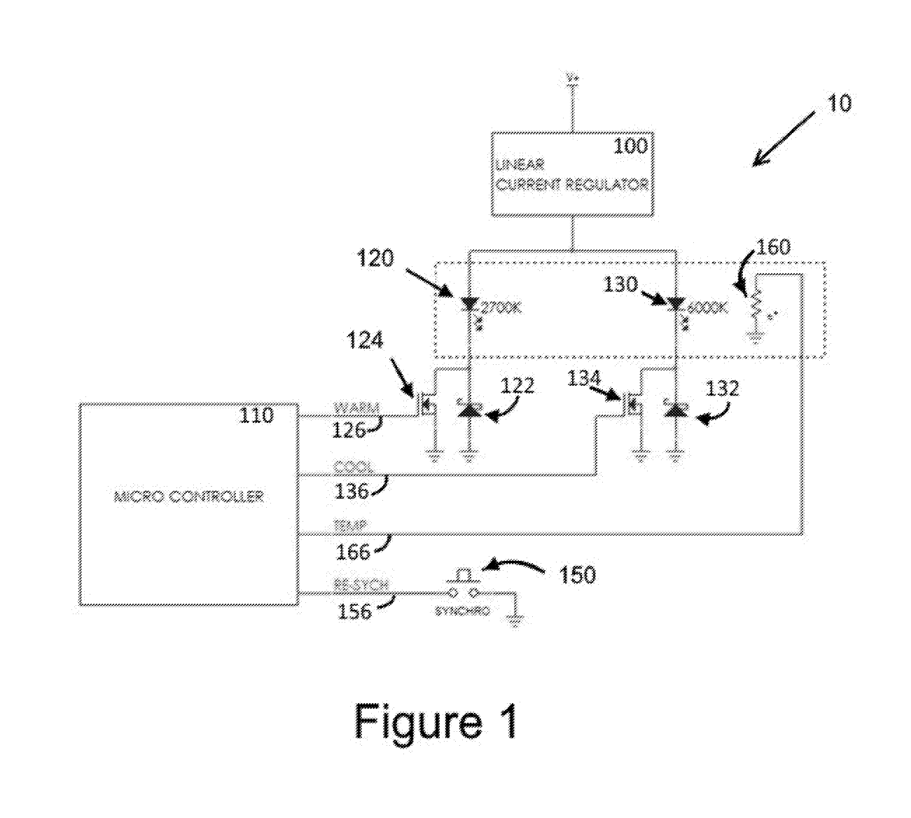

Now referring to FIG. 1, shown therein is an electrical circuit of the lighting device 10 comprising a color temperature gradation system, in accordance with an exemplary embodiment. In one embodiment the lighting device 10 comprises two LEDs: a first LED 120 (typically warm color temperature) and a second LED 130 (typically cold color temperature). Each of the first 120 and the second 130 LEDs emits light at a predetermined color temperature. The lighting device 10 is electrically fed by an electrical source, typically a fixed electrical source. The said electrical source current is configured to be distributed between the two LEDs 120 and 130. The resulting maximum power of the lighting device 10 (light engine) remains constant despite variation of the temperature (Kelvin) of the lighting device 10 (light engine).

To independently vary the percentage of power feeding each branch, two PWM type signals (COOL 136 and WARM 126) control the transistors 124 and 134 of these outputs.

According to an embodiment, the resulting color temperature of the LED light engine is altered by varying the operating frequency of the PWM.

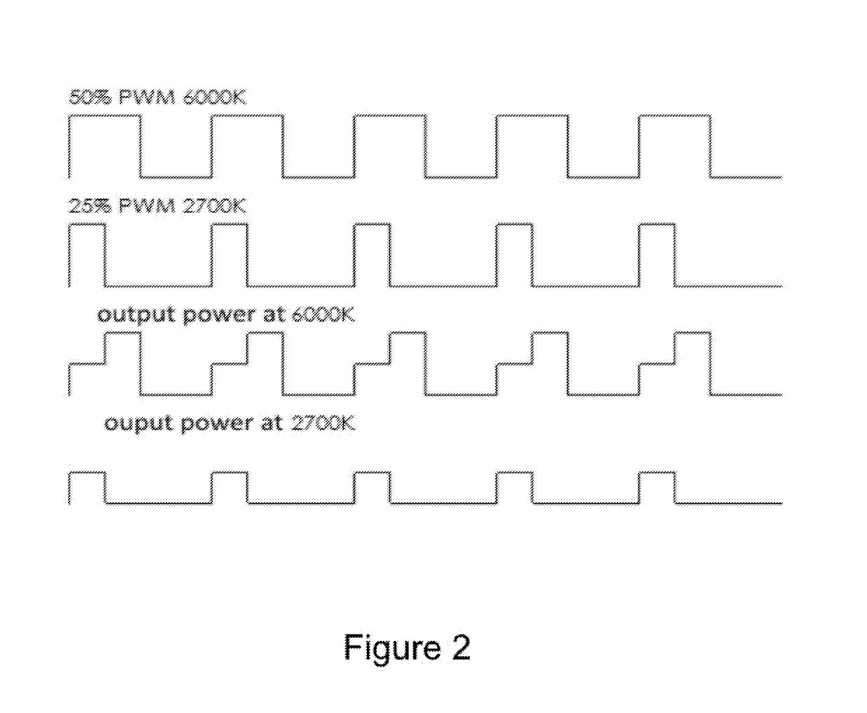

Now referring to FIG. 2, an example of PWM signals used with the lighting device is shown. In such an example, by providing a WARM signal having a 50% PWM and a COOL signal having a 25% PWM, the combination of the resulting lighting produces a first color temperature of the white LED light engine (the rendering of both white light sources). By varying the WARM and COOL signals, different color temperatures may be produced by the lighting device 10.

The lighting device 10 as described herein thus has an adjustable color temperature.

The use of low frequency PWM signals, such as a PWM signals having frequencies ranging between 100 Hz and 1000 Hz, has been found to produce flicker artefacts seen during a movement of the eye relative to the source whether by movement or scanning of the eye with respect to this light.

On the contrary, using of medium frequency PWM signals, such as PWM signals, having frequencies ranging between 3000 Hz and 15000 Hz eliminate or at least substantially reduce flicker artifacts. However, depending on the level of power used to feed the lighting device, such medium frequency PWM signal increases the generation of piezo electric audible side effect. As such, taking into account the power required for generating a source of usable light (12 to 100 Watts), the vibrations emitted by the light engine or the power source generally become perceptible to the ear.

The lighting device of the preferred embodiment uses high-frequency PWM signals, such as PWM signals having frequencies ranging between about 20,000 Hz and about 40,000 Hz. Using high-frequency PWM signals eliminate or at least substantially reduce flicker artefacts and may prevent piezo electric audible side effects.

According to the present embodiment, the LED light engine 10 further comprises a controller 110, such as a microcontroller (as shown at FIG. 1) or CPU. The controller 110 comprises a high frequency signal generator (not shown), such as a high frequency oscillator. The high frequency signal generator generates high-frequency PWM signals. For example, a microcontroller 110 comprising a 32 MHz oscillator may be used to generate PWM signal having frequencies of 32 KHz. One skilled in the art shall understand that any other method of generating high frequency PWM signal may be used within the controller 110 without departing from the present invention.

Still referring to FIG. 1, the electrical circuit of the lighting device 10 further comprises a linear current regulator 100 connected to each LED 120, 130 (e.g., as shown at FIG. 1, WARM 2700K LED and COOL 6000K LED). Each LED 120, 130 is connected to the transistor 124, 134 controlled by a PWM signal generated by the controller 110. In a preferred embodiment, the transistor 124, 134 is a MOS field-effect transistor N-channel. Each LED 120, 130 is typically also connected to a Schottky Diode 122, 132.

The controller 110 may be connected to a switch 150, such as, but not limited to, a push button switch (an open push switch). For example, the two different white LED lighting sources may be controlled using a signal from a home automation network, such as a mesh network of objects (i.e Zigbee™).

According to an embodiment of the present invention, a method of gradating the temperature of the lighting device 10 is disclosed. The method comprises the steps of varying the desired temperature thereby affecting the total output of both the second LED source 130 (e.g. 6000K LED) and the first LED source 120 (e.g. 2700K LED) to result in a warmer or colder white light rendering.

In some applications, such as for LED bulbs, the maximum operating temperature of the light engine is critical. Each scenario using a LED bulb are different and it should not affect the maximum safe operating temperature for LEDs. For instance, a LED bulb may be used in a system which allows only a minimum air flow and thus reduces the heat exchange to a minimum.

To avoid temperature overshoot of the light engine 10 and thus go beyond its thermal capabilities, a temperature sensor 160, such as, for example, an active folding thermistor probe of the power control, may be added to the light engine 10. In such embodiment (as shown at FIG. 1), the temperature sensor 160 is connected to the controller 110 and the controller 110 is configured to receive the temperature information surrounding the lighting device 10 from the temperature sensor 160.

In embodiment using an active folding thermistor probe, the probe is located proximal to the light engine but preferably not directly on it. Using this principle, an average thermal gradient is obtained. The thermal gradient thus obtained is generally more stable and less susceptible to air assembly variations than a temperature measured directly on the aluminum laminate PCB.

The lighting device 10 may further comprise dual metal-oxide-semiconductor field-effect transistor (MOSFET) drivers.

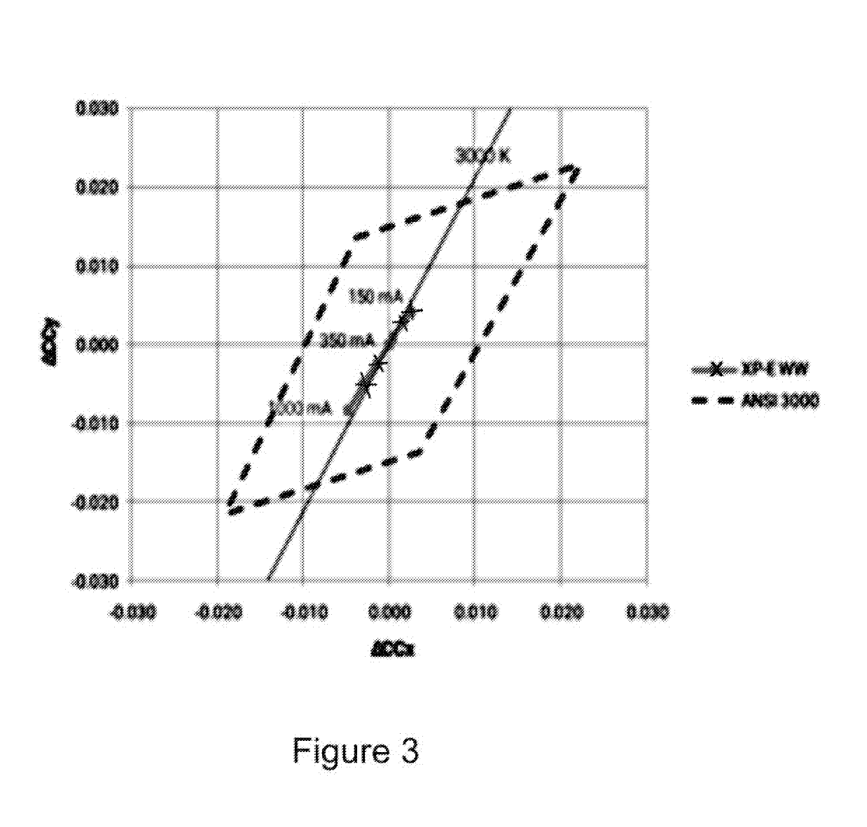

Shown at FIG. 3 is an example of chromatic shifting versus current of the lighting device, in accordance with one embodiment. The output of an exemplary embodiment of the lighting device as described herein is compared to the American National Standards Institute (ANSI) standard 3000.

Table 1 shows values of chromatic shifting versus current source, in accordance with one exemplary embodiment.

TABLE 1
Values of chromatic shifting versus current source,
in accordance with one exemplary embodiment.

| | Current (mA) | | | | | | |
|---|---|---|---|---|---|---|---|
| | 150 | 200 | 300 | 350 | 500 | 700 | 1000 |
| ΔCCx | 0.0026 | 0.0017 | 0.0005 | — | −0.0014 | −0.0030 | −0.048 |
| ΔCCy | 0.0042 | 0.0028 | 0.0009 | — | −0.0024 | −0.0050 | −0.0084 |
| ΔCCT | −10 | −6 | −1 | — | 5 | 9 | 13 |

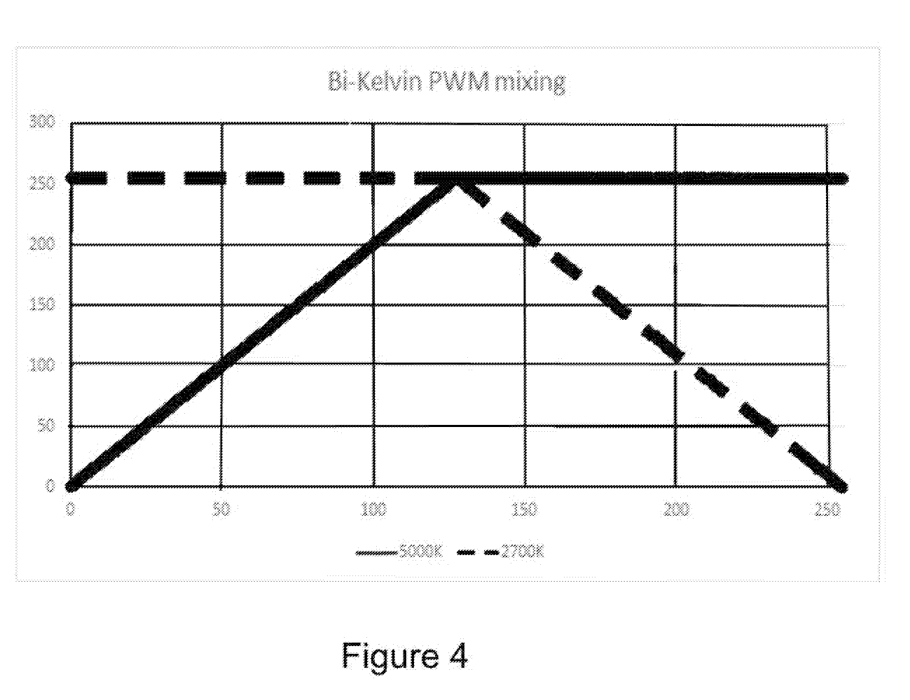

Now referring to FIG. 4, an example of controlling of gradation (dimming) the lighting device is shown. The PWM control and the regulated current source combination allow a quasi linear Kelvin control along the Bi-Kelvin PWM mixing curve. In this example, a cold LED source 130 (5000K) and a warm LED source 120 (2700K) are used. Understandably, any other LED sources having different color temperature could be used.

For example, when 0% PWM is supplied to the 5000K LED source 130 and 100% PWM to the 2700K LED source 120, the resulting color temperature of the lighting device 10 may be 2700K. For example, when 100% PWM is supplied to 5000K LED source 130 and 0% PWM is supplied to 2700K LED source 120, the resulting color temperature of the lighting device 10 may be 5000K. In another example, when 100% PWM is supplied to 5000K LED 130 and 100% PWM is supplied to 2700K LED 120, the resulting color temperature of the lighting device 10 may be 3850K.

Understandably, the control of the PWM signal may be linear, logarithmic, exponential or a combination of any function to produce a specific resulting color temperature as a function of the inputted PWM signal.

The controller 110 determines the first and the second portions of the PWM that need to be supplied to the first white LED 120 and the second white LED 130, respectively. As described herein, the first portion of the PWM signal is from about 0 to about 100% of the PWM signal and the second portion of the PWM signal is from about 0 to about 100% of the PWM signal.

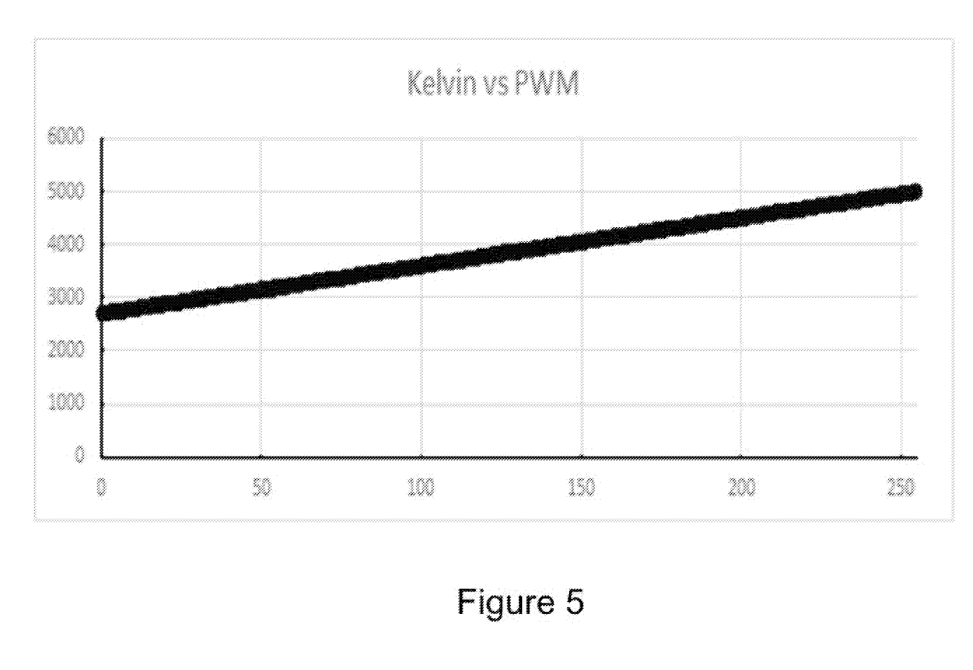

Now referring to FIG. 5, an example of output color temperature of the lighting device 10 as a function of the PWM is shown.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A lighting device with color temperature gradation comprising:
a first light source having a first color temperature;
a second light source, having a second color temperature, the second color temperature being higher than the first color temperature;
a controller fed by an electric signal and connected with the first light source and with the second light source, the controller being configured to
generate a pulse width modulation (PWM) signal; and
supply the first light source with a first portion of the PWM signal and the second light with a second portion of the PWM signal.

2) The lighting device with color temperature gradation of claim 1, the color temperature of the second light source being higher than the color temperature of the first light source by at least 2200 Kelvin (K).

3) The lighting device with color temperature gradation of claim 1, the first light source and the second light source being Light-Emitting Diodes (LEDs).

4) The lighting device with color temperature gradation of claim 3, the first light source and the second light source being white LEDs.

5) The lighting device with color temperature gradation of claim 3, the first light source being a cold color temperature LED and the second light source being a warm color temperature LED.

6) The lighting device with color temperature gradation of claim 1, the color temperature of the second light source being higher than the color temperature of the first light source by at least 2200 Kelvin (K).

7) The lighting device with color temperature gradation of claim 1, the first portion of the PWM signal being comprised between 0% to 100% of the PWM signal and the second portion of the PWM signal being comprised between 0% to 100% of the PWM signal.

8) The lighting device with color temperature gradation of claim 1, the controller being a high frequency PWM controller.

9) The lighting device with color temperature gradation of claim 1, the PWM signal generated by the controller having a frequency between 20,000 Hz and 40,000 Hz.

10) The lighting device with color temperature gradation of claim 1, the first color temperature being between 2800K and 3200K.

11) The lighting device with color temperature gradation of claim 1, the second color temperature being between 5500K and 6000K.

12) The lighting device with color temperature gradation of claim 1, the lighting device further comprising a temperature sensor connected to the controller and configured to provide a feedback signal to the controller.

13) The lighting device with color temperature gradation of claim 1, the lightning device further comprising a first and a second Schottky diodes, the first Schottky diode being connected to the first light source and the second Schottky diode being connected to the second light source.

14) A method of gradating the color temperature of a lighting device, the method comprising the steps of:
generating a pulse width modulation (PWM) signal;
supplying a first light source with a first portion of the generated PWM signal, the light source having a first color temperature;
supplying a second light source with a second portion of the PWM signal, the second light source having a second color temperature; and
emitting a light having an output color temperature in between of the first color temperature and the second color temperature.

15) The method of claim 14, the method further comprising varying the first portion of the PWM signal to be comprised in a range of 0% to 100% of the PWM signal.

16) The method of claim 14, the method further comprising varying the second portion of the PWM signal to be comprised in a range of 0% to 100% of the PWM signal.

17) The method of claim 14, wherein the second color temperature is at least 2200K higher than the first color temperature.

18) The method of claim 14, the first light source being a cold color temperature LED and the second light source being a warm color temperature LED.

19) The method of claim 14, wherein the PWM signal is generated by a controller fed by electric current and connected to the first and second light sources.
